(19) United States
(12) Patent Application Publication
(10) Pub. No.: US 2002/0116486 A1
(43) Pub. Date: Aug. 22, 2002

(54) Method of supervising and controlling a transport network

(75) Inventors: Famory Toure, Massy (FR); Julien Robinson, Paris (FR)

Correspondence Address: SUGHRUE, MION, PLLC, Suite 800, 2100 Pennsylvania Avenue, N.W., Washington, DC, 20037-3213, US

(73) Assignee: ALCATEL

(21) Appl. No.: 10/078,375

(22) Filed: Feb. 21, 2002

(30) Foreign Application Priority Data
Feb. 22, 2001 (FR) 01 02 390

(51) Int. Cl. G06F 15/173; G06F 15/16

(52) U.S. Cl. 709/223; 709/230; 709/246

(57) ABSTRACT

A method of using a supervision client based on an OPC protocol to supervise and control a transport network including a data server based on an SNMP protocol consists of connecting the supervision client to a gateway for providing a connection between the data server and the supervision client using a description of the data of the data server from a management information base.

### CROSS-REFERENCE TO RELATED APPLICATIONS

This application is based on French Patent Application No. 01 02 390 filed Feb. 22, 2001, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method of using a client device to supervise and control a transport network including a server based on the simple network management protocol (SNMP).

The field of the invention is that of supervising and controlling a transport network, notably a telecommunication transport network.

2. Description of the Prior Art

FIG. 1a) shows an existing system for supervising a telecommunication transport network.

This kind of system includes equipments 1 to be supervised connected to one or more servers 2, generally in accordance with the simple network management protocol (SNMP). The server 2 can itself receive data from one or more equipments 1.

Some equipments are not based on the SNMP. In this case, if the equipment 1 has sufficient computing power, an SNMP agent 10 enabling use of the SNMP between the equipment 1 and the server 2 is included in the equipment 1 whose manufacturer supplies a management information base (MIB) indicating the resources (or data) accessible on the equipment. If the equipment 1 to be supervised does not have sufficient computing power to support an SNMP agent, and is based on the Sony “Firewire” protocol, for example, which is an “Ethernet” protocol, the SNMP agent 10 is in the server 2.

The server 2 is connected to one or more supervision client devices 3 for storing data or presenting data, generally in graphical form, to a supervision and control operator.

The supervision client device is referred to hereinafter as the supervision client.

Control and supervision software is installed on the supervision client 3 and the server 2 if the SNMP agent is in the server 2. The protocol for communication between the server 2 and the supervision client 3 is then specific to the installed software.

Software that might be mentioned in this connection includes the Hewlett Packard “HP Open View” system, which is complex and concerns only network supervision, or the Microsoft “Visio” software, which is an easy to use design tool for visually representing the links between the various equipments of a network, but does not provide network control functions, such as presenting alarms concerning the supervised network or supervised data histories.

Mention may also be made of gateways conforming to the CORBA (Common Object Request Broker Architecture) standard for communication between applications: they facilitate access to the SNMP but do not provide network supervision.

FIG. 1b) shows another supervisory system. It includes a supervision and control client 3′ connected directly to the equipments 1 to be supervised and on which supervision and control software programmed using existing components is installed.

This kind of program can be developed using an “ActiveX” component 30′ to access an equipment based on the SNMP using the “Visual Basic” programming language: this “ActiveX” component encapsulates the application programming interface (API) of the SNMP, which facilitates developing the software. Although this facilitates the programmer's task, development is still required for visualizing, animating and controlling the network to be supervised.

Animating the network consists of presenting the data available to the supervisor in real time or in historical form, or modifying that data.

In a field other than that of transport network supervision, there exist automated process or plant supervision tools based on the OPC (Object linking and embedding for Process Control) standard, a standard for communication between applications used in Microsoft Windows.

FIG. 2 shows one of these tools.

The equipment 1 to be supervised, including sensors, for example, sends its data to a server 2 using a “Firewire” communication protocol. The server 2 may itself be connected to a supervision client 3 using an OPC communication protocol enabling presentation of the data, generally in graphical form.

These “off the shelf” tools, or tools that have necessitated a small amount of development, generally have multiple data animation functions (zoom, panorama, presentation of the network in multiple layers, etc.); they have good ergonomics, but are not suitable for supervising a transport network like that shown in FIG. 1, in particular one including equipments to the SNMP standard.

The OPC-type Iconics “Graph WorX32” software is used to monitor temperature sensors, input-output, potentiometers, voltage indicators, etc.

The object of the present invention is therefore to be able to use the above kind of supervisory tools based on the OPC standard to supervise a transport network including in particular a large number of equipments to the SNMP standard.

### SUMMARY OF THE INVENTION

The invention provides a method of using a supervision client based on an OPC protocol to supervise and control a transport network including a data server based on an SNMP protocol, which method consists of connecting the supervision client to a gateway including means for providing a connection between the data server and the supervision client using a description of the data of the data server from a management information base.

According to one feature of the invention the description from a management information base is developed with an object-oriented language based on the XML language.

According to one feature of the invention the data server is a server of a telecommunication transport network or a data transport network.

The invention also provides a data server based on an SNMP protocol including a gateway adapted to provide a connection with a supervision client based on an OPC protocol using a description of the data of the server from a management information base.

Other features and advantages of the invention will become clearly apparent on reading the following description, which is given by way of non-limiting example and with reference to the accompanying drawings.

### BRIEF DESCRIPTION OF THE DRAWINGS

FIGS. 1a) and 1b), already described, show diagrammatically an existing system for supervising a transport network.

FIG. 2, already described, shows diagrammatically an existing system for supervising an industrial process.

FIG. 3 shows diagrammatically a system in accordance with the invention for supervising a transport network.

### DETAILED DESCRIPTION OF THE PREFERRED EMBODIMENT

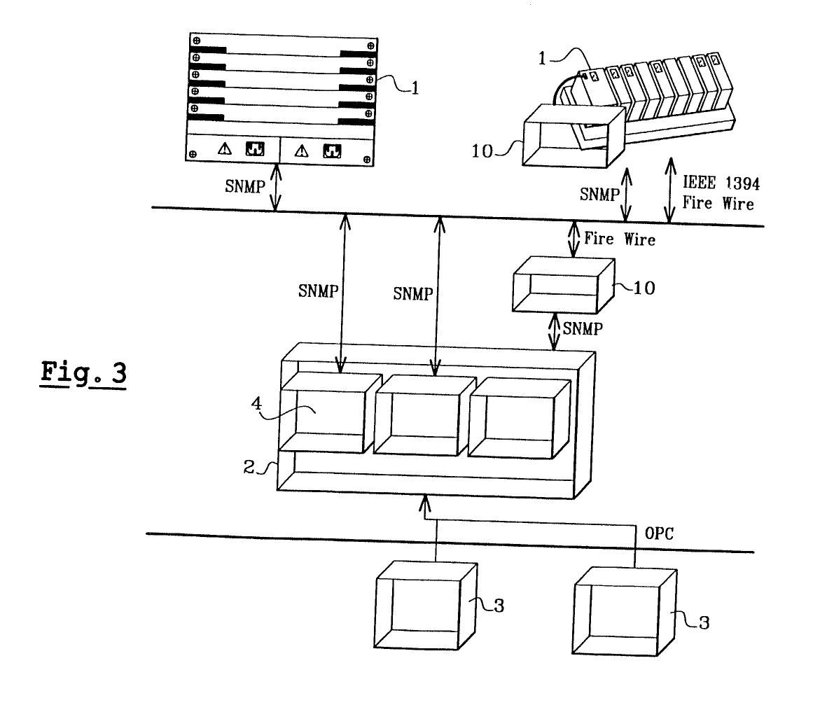

FIG. 3 shows a supervision system according to the invention. Its application to a telecommunication network will be more particularly considered.

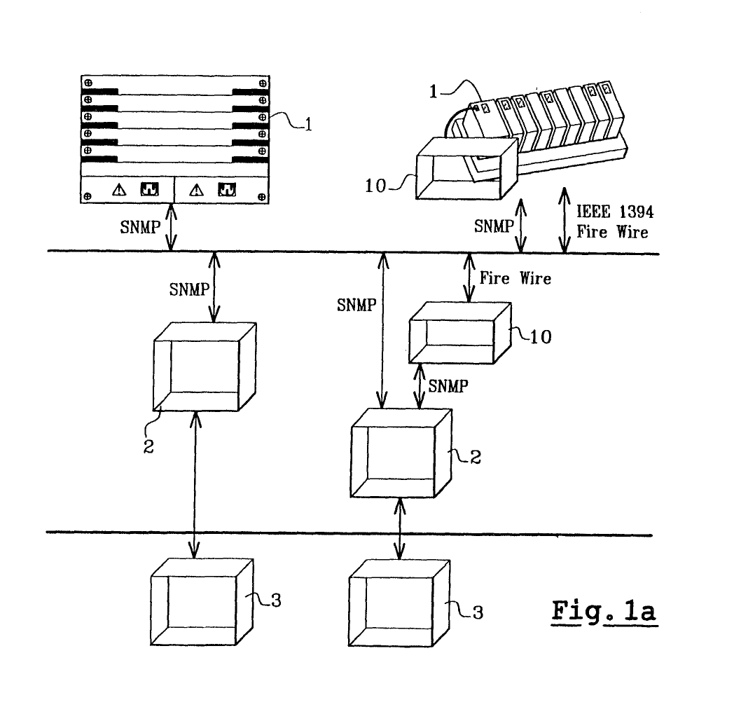

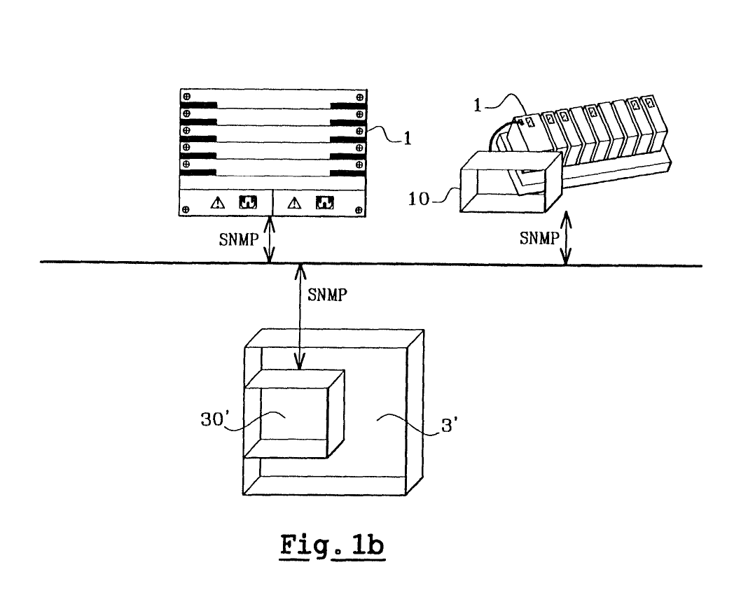

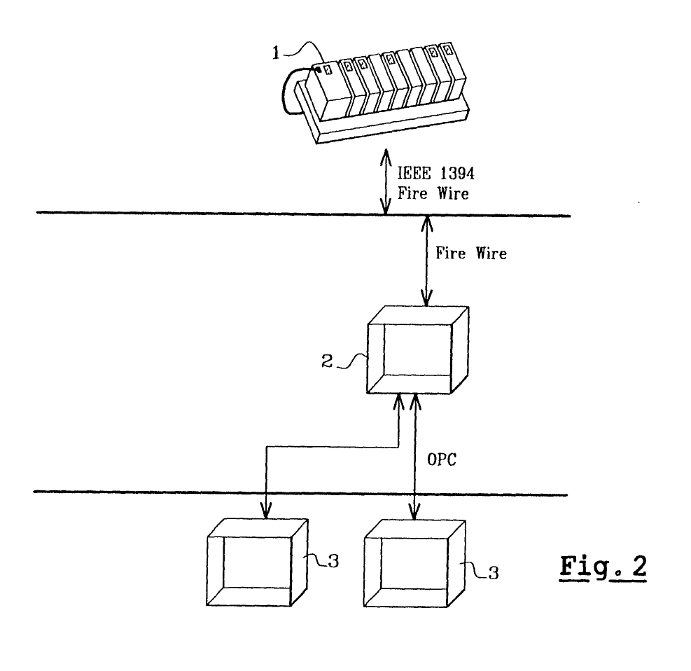

The equipment 1 to be supervised, such as a router, a switch, etc., sends its data to a server 2; the server 2 can receive data from one or more equipments 1. As already described with reference to FIG. 1a), if the equipment 1 to be supervised does not include an SNMP agent, but communicates using a “Firewire” protocol, then an SNMP agent 10 is in the server 2.

According to the invention, the connection between the server 2 and the OPC supervision client 3 is provided by one or more gateways integrated into the server 2, and in particular a gateway 4; the server 2 can also be connected to a plurality of supervision clients 3.

The gateway 4 is a program defining a protocol for communication between an SNMP server and an OPC client for visualizing the data to be supervised, preferably in tree form and animated. The data supplied by the server 2 consists of the objects to be supervised and their properties. By “objects” is meant the equipments 1 of the transport network concerned.

The program, consisting of a series of instructions, includes a first data description step. The description is produced by scrolling through and choosing the data to be supervised from the data in a Management Information Base (MIB) and defining the data using the syntax of an object-oriented language such as the extended Markup Language (XML).

The description of an element (or class) of the management information base in XML is of the form:

<class name=“Router” isa=“SNMPObject”>

<Attributes>

<OID Name=“sysDescr” type=“string” id=“system.sysDescr.0”/>

<OID Name=“sysName” type=“string” id=“system.sysName.0”/>

<OID Name=“sysUpTime” type=“r8” id=“system.sysUpTime.0”/>

</Attributes>

</class Router>

The description of an instance of the above class, here an equipment to be supervised, is then, for example:

<Router name=“COMPANY_ROUTER1” IPAddress=“195.9.12.245”/>

It is possible to describe the network in hierarchical form, for example using the following instructions:

<Router name=“COMPANY_ROUTER1” IPAddress=“195.9.12.245”/>

<Children>

<Compaq name=“NT_Machine1” IPAddress=“195.9.12.205”>

<Compaq name=“NT_Machine2” IPAddress=“195.9.12.206”>

</Children>

</Router>

In accordance with a protocol for communication between COM/DCOM (Component Object Model/Distributed Component Object Model) applications, which in particular defines components that can be reintegrated into other applications, the objects to be supervised are created dynamically once they have been described using an XML scheme.

A dynamic invocation interface can be used, for example, such as that which exists in Java, Corba, Visual Basic in particular: these interfaces enable an instance of a class to recover the attributes of a sister class or to invoke a method of a sister class during execution of the program.

In the practical implementation used, a Generic Object is created for describing classes and instances of those classes and which redefines the dynamic invocation interfaces.

The Generic Object has the advantage that a single object can be used to describe the supervised objects. This also provides access to the objects from an office automation application such as Excel, Word, Access or Visual Basic, for example, using the following syntax:

CompanyRouter1 .sysDescr=“This is the first router of the Company”.

The method proposed supervises and controls SNMP equipments and non-SNMP equipments equally well. It also uses a large number of existing OPC supervision systems, as well as an office automation application (Excel, Word, Access, Visual Basic).

The transport network to which the method relates can be that of a telecommunication network or a data network.

There is claimed:

1. A method of using a supervision client based on an OPC protocol to supervise and control a transport network including a data server based on an SNMP protocol, which method consists of connecting said supervision client to a gateway including means for providing a connection between said data server and said supervision client using a description of the data of said data server from a management information base.

2. The method claimed in claim 1 wherein said description from a management information base is developed with an object-oriented language based on the XML language.

3. The method claimed in claim 1 wherein said data server is a server of a telecommunication transport network.

4. The method claimed in claim 1 wherein said data server is a server of a data transport network.

5. A data server based on an SNMP protocol including a gateway adapted to provide a connection with a supervision client based on an OPC protocol using a description of the data of said server from a management information base.
